(19) United States
(12) Patent Application Publication
(10) Pub. No.: US 2015/0252783 A1
(43) Pub. Date: Sep. 10, 2015

(54) METHOD FOR OPERATING A WIND TURBINE, AND WIND TURBINE

(71) Applicant: SENVION SE, Hamburg (DE)

(72) Inventors: Carsten Eusterbarkey, Simonsberg (DE); Nadine Scharlaug, Hamburg (DE)

(21) Appl. No.: 14/718,997

(22) Filed: May 21, 2015

Related U.S. Application Data
(63) Continuation of application No. PCT/EP2013/003509, filed on Nov. 21, 2013.

(30) Foreign Application Priority Data
Nov. 21, 2012 (DE) 102012221289.2

(51) Int. Cl. F03D 7/02; F03D 11/04; F03D 1/06

(52) U.S. Cl. CPC F03D 7/0204; F03D 1/06; F03D 11/04

(57) ABSTRACT

A method for operating a wind turbine having a nacelle disposed in a rotatable manner on a tower and a rotor having three rotor blades, which can be brought into a standstill position after a stoppage command, and in which at least two of the three rotor blades can be pitched about a rotor-blade longitudinal axis, which includes rotating the nacelle into an azimuth position transverse to a wind direction to attain the standstill position, bringing/holding a rotor blade into a range of an operating position that corresponds substantially to a blade pitch angle in a partial-load range below a full-load range of the wind turbine and bringing/holding each of the other two rotor blades into a range of a feathered position, wherein the rotor, after attainment of the standstill position, is stabilized by incident wind flowing transversely in relation to a direction of a rotor axis.

### CROSS-REFERENCE TO RELATED APPLICATIONS

This application is a continuation of PCT/EP2013/003509, filed Nov. 21, 2013, and claims priority to DE 102012221289.2, filed Nov. 21, 2012.

### BACKGROUND OF INVENTION

1. Field of Invention

The invention relates both to a method for operating a wind turbine that comprises a nacelle disposed in a rotatable manner on a tower, and that comprises a rotor having three rotor blades, of which at least two can be pitched about a rotor-blade longitudinal axis, wherein the wind turbine is brought into a standstill position after a stoppage command, and to a corresponding wind turbine.

2. Brief Description of Related Art

The present patent application deals with wind turbines having a substantially horizontal rotor axis. Such a wind turbine may be stopped during its operation for a variety of reasons. Thus, maintenance work, repair work or the like is only possible when a wind turbine has been stopped. Particular requirements arise, in particular, in the case of offshore wind turbines, if the latter are approached by helicopter in order to set down technicians to perform maintenance or repair work on the wind turbine. Approaching a wind turbine by helicopter is subject to particular safety regulations, and requires that the wind turbine has been stopped, and it is also necessary for the rotor position to meet particular requirements. Thus, when in the stopped state, the rotor should have a position in which the rotor blades project as little as possible in the vertical direction beyond the nacelle, to enable the helicopter to approach. It is desirable, for example, that the rotor of the wind turbine is not rotating as the helicopter approaches, so as not to cause any changes in the flow conditions.

Known from DE 10 2010 000707 is a method for operating a wind turbine, in which a rotor stoppage device is provided, which brakes or arrests the rotor, wherein, in addition, the stoppage position of the rotor is in each case sensed independently by at least two or more sensing means that are operated, or can be operated, independently of each other, and the sensed stoppage position of the rotor is verified. The approach of a helicopter is allowed only upon double verification of the stoppage position.

From WO 2004/111443 A1 it is known to stop a wind turbine if the wind turbine is approached by a helicopter, and to initiate the stoppage wirelessly from the helicopter.

Moreover, there are numerous safety rules relating to approach by helicopter, in which it is required that the rotor be rotated approximately 90° out of the wind, i.e. be brought into a transverse orientation in relation to the wind, and that the rotor be arrested either in the so-called “Y” position, with one blade vertically downward, or in a position with one rotor blade pointing horizontally in the wind direction. For this purpose, the rotor is usually first immobilized and then the nacelle is rotated out of the wind.

Particularly in strong wind, the usual process of approaching the desired rotor position by means of target braking and/or by means of a positioning means, or an auxiliary positioning drive, and immobilizing the rotor in the desired position, results in high loads on the positioning drive and, when in the immobilized state, upon the braking system, and upon the gear mechanism in the case of gearbox systems, since in the case of the latter the brake is usually disposed on the high-speed gear shaft. This braking, or immobilizing, may result in so-called “false brinelling” in the gear toothing, which may be the point of origin for subsequent toothing damage.

### BRIEF SUMMARY OF THE INVENTION

The invention is therefore based on the object of improving the approaching and holding of a predefined rotor position, in particular in the approaching of offshore wind turbines by helicopter.

This object is achieved by a method for operating a wind turbine that comprises a nacelle disposed in a rotatable manner on a tower, and a rotor having three rotor blades, of which at least two can be pitched about a rotor-blade longitudinal axis, wherein the wind turbine is brought into a standstill position after a stoppage command, which method is developed in that, for the purpose of attaining the standstill position, the nacelle is rotated into an azimuth position transverse to the wind direction, a rotor blade is brought into a range of an operating position or held in a range of an operating position that, in particular, corresponds substantially to a blade pitch angle in a partial-load range below a full-load range of the wind turbine, and two other rotor blades are each brought into a range of a feathered position or held in a range of a feathered position, wherein the rotor, after attainment of the standstill position, is stabilized by the incident wind flowing transversely, in particular sideways, in relation to the direction of the rotor axis.

The invention is based on the basic concept that a suitable position of the rotor can also be attained other than by mechanical positioning and immobilizing or arresting, namely, by appropriate and selective pitching of the rotor blades of the rotor. Since, in the standstill position, the nacelle and also the rotor are rotated out of the wind by 90°, the wind flows on to the rotor in an abnormal manner, namely, from the side. In this case, the aerodynamic action of the rotor blades differs significantly from that in normal operation, in which incident flow is from the front. The measure of bringing two rotor blades into the range of a feathered position and leaving one rotor blade in an operating position, or bringing it into this position, has the effect that the two rotor blades set in the range of the feathered position present their broad side to the wind, such that the wind forces the latter into the wind direction.

Since, in the case of a three-blade rotor, the two rotor blades are 120° apart, this results in a stable position, in which one of the two rotor blades is disposed above a horizontal line through the rotor axis, and the other is disposed beneath this line. The third rotor blade, which is set in the range of the operating position, presents its narrow side to the sideways incident wind in each position, such that the wind exerts less force upon this one rotor blade. The latter will therefore be subjected to less thrust in the wind direction and, owing to the resultant asymmetry in the distribution of force to the three rotor blades relative to the rotor rotation axis, remains oriented into the wind. The position attained thus is a very low-load position, which results in a stable, low-idle positioning of the rotor in a positioning that is favorable for an approach by helicopter.

The position according to the invention is also more stable, and therefore preferred to the opposite configuration, not according to the invention, in which only one rotor blade is held in the feathered position and two rotor blades are held in an operating position. In this case, the sideways incident wind exerts pressure only upon the one rotor blade, in the feathered position, that is positioned, or oriented, into the incident wind. The force that is exerted upon the individual rotor blade in the feathered position by the wind in this position is not significantly greater than the force exerted upon the other two rotor blades, which likewise present their narrow side to the wind, but which are at an angle of 60° thereto. This position is considerably more unstable. Since two of the rotor blades are in the operating position, the configuration is additionally liable, in the case of a turning wind, to result in the rotor starting up again if the wind flows against the wind turbine with a motion component from the front.

In this case, advantageously, the range of an operating position is a range in which profile chords of the outer 30% of the blade length of the rotor blade lie substantially, in particular within approximately ±10°, in the rotor plane, wherein the range of the feathered position is a range in which profile chords of the outer 30% of the blade length of the rotor blade are substantially, in particular within approximately ±15°, perpendicular to the rotor plane. The angle ranges for the range of the operating position and the range of the feathered position take account of the fact that, on the one hand, the rotor blades are in themselves twisted, including, to a certain extent, within the blade tip region, such that the positioning depends on the type of rotor blade. On the other hand, account is also taken of the fact that for the purpose, according to the invention, of rotor positioning in the case of lateral incident flow, an ideally functioning feathered position may necessitate a certain variation, particular to a rotor blade, around an exact feathered position. This again depends on the type of rotor blade, and possibly on a wind speed and on the side from which the wind is incident on the rotor blade.

According to the invention, the feathered position is understood to mean both a positive feathered position and a negative feathered position. In the case of an upwind turbine, the positive feathered position is that in which the rotor blade is oriented with the profile rear edge toward the nacelle, whereas the negative feathered position has the rear edge facing away from the nacelle. If the two rotor blades held in the range of the feathered position are held in the positive feathered position, in the standstill position one rotor blade receives the laterally incident wind on the suction side, whereas the other rotor blade receives the incident flow on its pressure side. These differing profiles, in turn, have an effect upon the fact that the pressure exerted by the laterally incident wind upon the two rotor blades differs. For this purpose, again, a limited difference in the setting of the feathered position, or the selection of a positive feathered position in combination with a negative feathered position, may show positive results and promote a more stable standstill position of the rotor.

The optimum choice of standstill positions, or operating positions and feathered positions, depends on the type of wind turbine and rotor blades, and may be determined, on the one hand, by computational simulations and, on the other hand, by tests on the installed wind turbine. Likewise, in this way it can be determined whether it is more favorable to position the nacelle such that the rotor receives the incident wind laterally from the left or the right, i.e. transversely in relation to the direction of the rotor axis. However, the preferred position may also depend on the helicopter that is used, the helicopter winch for lowering personnel usually being disposed at the side.

It is provided, advantageously, that the rotor, after attainment of the standstill position, is additionally immobilized and/or arrested for a period of time, in particular for the duration of a helicopter approach. This may be particularly necessary if the regulations for a helicopter approach prohibit a rotor not being immobilized or not arrested. As a result of the aerodynamic stabilization according to the invention, however, the rotor is in a particular low-load situation, such that immobilizing or arresting is effected with particularly low load and, in particular, false brinelling, resulting from braking or stoppage, no longer occurs, or scarcely occurs, such that toothing damage also no longer occurs. In the context of the present invention, immobilizing is understood to mean a force-closed fixing of the rotor, arresting being understood to be a form-closed fixing.

Preferably, an adjustment of at least one blade angle is effected in dependence on a measured rotor position, wherein, in particular, the adjustment is effected non-continuously and, after stabilization of a desired rotor position, the adjusted blade angles that have been set are retained. The adjustment may be necessary if, for example, the vertical flow profile of the laterally incident wind does not correspond to a standard profile, such that a certain adjustment of the blade angles, in particular of the two rotor blades that are in the feathered position, is necessary in order to achieve a rotor positioning that is favorable for an approach by helicopter. Once this positioning has been achieved, the thus adjusted blade angles can be fixed, or retained.

The nacelle is preferably moved in a predefined direction of rotation, wherein, in particular in the case of a cable-twist signal being present, it is moved in the direction opposite to the predefined direction. The preferred direction may have been ascertained, for example, in simulations or in tests on the installed wind turbine, wherein it was ascertained that the rotor in the standstill position is supported aerodynamically in a particularly stable manner if it receives incident flow from the left or from the right. This can then define the preferred, or predefined, direction of rotation. However, the presence of a cable-twist signal, in the case of which the cables of the wind turbine, which can usually be twisted up to approximately 720°, would be twisted excessively in the case of the respective twist, may constitute the exception, in the case of which the direction of rotation is then in the opposite direction. In this case, it is possible to stop in the nacelle position that is identified as being somewhat unfavorable or, if there is more time available for this, rotation may be progressed further so as to achieve the nacelle positioning identified as more favorable. This has the further advantage of greater unwinding of the cable twist. Depending on the type of helicopter, it may also be the case that only one direction is possible; in the case of a laterally mounted winch, in particular, the helicopter preferably approaches only from one side.

In a preferred development, the rotation of the nacelle and the alteration of the blade angles are effected only when the nacelle has already been rotated substantially out of the wind, in particular by more than 60°. This has the advantage that, as a result of the rotor having been rotated out of the wind, the load on the rotor is first reduced before the blades are pitched. For this purpose, the rotor is first brought into a low-load idling state, in which preferably all three blades are in the feathered position.

Preferably, a standstill position of the rotor is set, in which there prevails a rotor position that is substantially between a “Y” position, with one rotor blade pointing vertically downward, and a position rotated with respect to the latter, in which the rotor blade, rotated in the range of an operating position, is oriented horizontally and pointing to the wind, wherein the assumed rotor position is kept with a deviation of less than ±10°, in particular less than ±5°. Ideally, the setting of the rotor position is effected, without deviation within the said range, between the “Y” position, with a rotor blade pointing vertically downward, and a rotated position, with a rotor blade pointing horizontally into the wind. In the case of an aerodynamic stabilization, however, a slight, in particular temporary, deviation from this range has to be taken into account, owing to the inconstancy of the wind conditions. This deviation should be kept as small as possible. It is thus possible, advantageously, to select a positioning between the two said extreme positions that allows a particularly large amount of play in both directions, without departing from the desired range. In this middle position, the rotor blade, held in the range of the operating position, is at an angle, relative to the horizontal, of approximately 15° above the horizontal.

The object on which the invention is based is also achieved by a wind turbine that comprises a nacelle disposed in a rotatable manner on a tower, a rotor having three rotor blades, of which at least two can be pitched about a rotor-blade longitudinal axis, a control means, in particular comprising a data processing system, a wind direction sensor and a rotor-position sensor, wherein the control means is designed to bring the wind turbine into a standstill position after a stoppage command, which control means is developed in that the control means is designed to rotate the nacelle, in particular by means of an azimuth drive, into an azimuth position transverse to the wind direction after the stoppage command has been received, to bring a rotor blade into a range of an operating position, or to hold it in a range of an operating position, in particular by means of a blade pitch control drive, and to bring two other rotor blades each into a range of a feathered position, or to hold them in a range of a feathered position, in particular by means of blade pitch control drives.

In this case, the control means, which, in particular, is an operating control system of the wind turbine, receives signals from the wind direction sensor and the rotor-position sensor, in order to determine the standstill position into which the wind turbine is to be moved. For this, the control means of the wind turbine is designed to perform the previously described method according to the invention. The control means advantageously comprises a data processing system, which is set up to control the operation of the wind turbine by means of a control software.

Preferably, the wind turbine has an active yaw control system, by means of which the positioning of the nacelle is effected.

Likewise preferably, the wind turbine has a braking means and/or an arresting means, by means of which the rotor can be fixed, at least for a short time, after attainment of a desired rotor position.

The control means is preferably designed to select the rotor blade, which is positioned in the range of an operating position, in dependence on a rotor position signal and a wind direction signal. This is advantageous, in particular, when the wind turbine has already been rotated substantially out of the wind and is idling slowly. In this case, it is possible to select, for the operating position, that rotor blade which will be the next to attain the horizontal position directed into the wind. If this rotor blade is likely to rotate past this position, the subsequent rotor blade can be selected. In this way, attainment of the standstill position of the rotor can be achieved particularly rapidly.

Advantageously, the control means is designed to adjust at least one blade angle in dependence on a measured rotor position. Likewise, the control means is preferably designed to retain the adjusted blade angle after stabilization of a desired rotor position.

The features, advantages and properties mentioned in connection with the subject-matters of the invention, i.e. the method according to the invention and the wind turbine according to the invention, each also apply to the other subject-matter of the invention, since the method according to the invention and the wind turbine according to the invention relate to each other, and the method according to the invention can be executed by means of the wind turbine according to the invention.

Further features of the invention are disclosed by the description of embodiments according to the invention, together with the claims and the appended drawings. Embodiments according to the invention may fulfill individual features or a combination of a plurality of features.

### BRIEF DESCRIPTION OF THE DRAWINGS

The invention is described in the following, without limitation of the general concept of the invention, on the basis of exemplary embodiments and with reference to the drawings, wherein express reference is made to the drawings in respect of all details according to the invention not explained in greater detail in the text. There are shown in:

FIG. 1 a schematic representation of a wind turbine, comprising a rotor and a pitchable rotor blade,

FIG. 2 a schematic representation of a wind turbine, in a standstill position according to the invention, and

FIG. 3 a schematic representation of a wind turbine, in a further standstill position according to the invention.

In the drawings, elements and/or parts that are the same or of the same type are in each case denoted by the same reference numerals, such that they are not each presented over again.

### DETAILED DESCRIPTION OF THE INVENTION

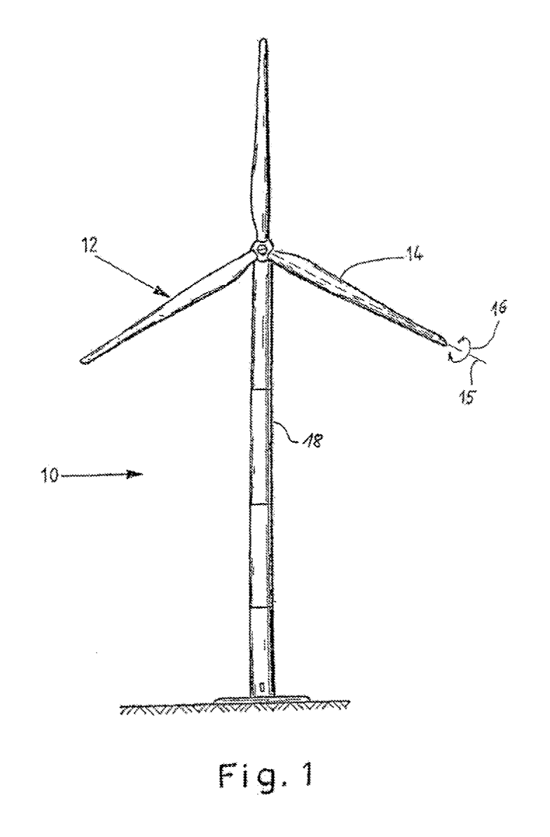

Shown schematically in FIG. 1 is an example of a wind turbine 10, comprising a rotor 12 and a rotor blade 14, as well as two further rotor blades 14, wherein, for example, a rotor blade 14 can be pitched about its rotor-blade longitudinal axis 15, along the pitch direction 16. This is likewise provided in a corresponding manner for at east one of the other two rotor blades 14, all three rotor blades 14 preferably being pitchable.

The rotor blades 14 represented in FIG. 1 are each represented in an operating position, wherein, for example in the case of the rotor blade 14 directed vertically upward, the profile front edge is the substantially straight edge on the right side, and the profile rear edge is the edge with the more pronounced curve, on the left side. In this case, in particular in the region of the rotor-blade tip, the profile chords that connect the profile front edge to the profile rear edge lie in the rotor plane, or substantially in the rotor plane. In the case of a feathered position, the cross section of the rotor blade would appear substantially narrower.

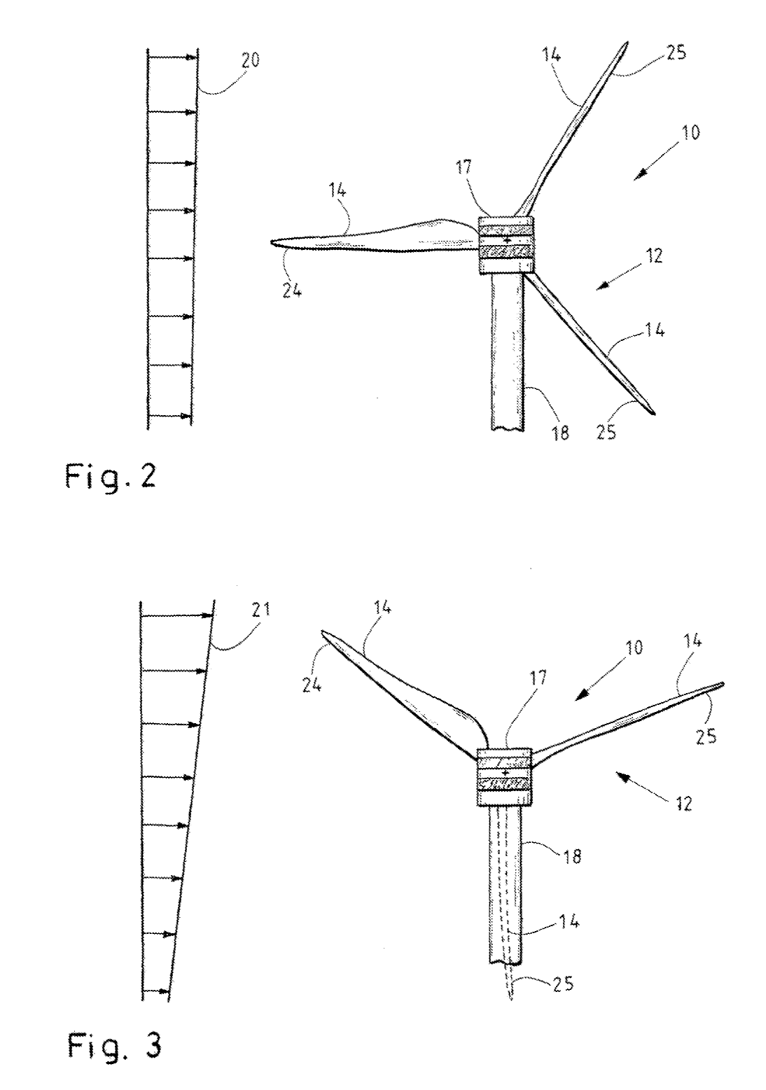

A first standstill position of the rotor 12, according to the invention, is represented in FIG. 2. The rotor 12 and the wind turbine 10 are represented from a rear view, i.e. the nacelle 17 conceals the rotor hub and the central regions of the rotor blades 14.

FIG. 2 shows a rotor blade 14 in an operating position 24, and two rotor blades 14 that are each in a feathered position 25, having a correspondingly reduced cross-sectional profile in the view represented. The rotor blade 14 in the operating position 24 is in a substantially horizontal position, and from the left receives an incident wind flow, the wind gradient 20 of which is represented on the left side of FIG. 2. In this case, the wind speed is the same at the various vertical positions, such that the incident flow on the rotor 12 from the side is uniform over the entire rotor height. In this case, the rotor blade 14 in the operating position 24 does not present much working surface to the wind, whereas the two rotor blades 14 set in the feathered position 25 present a considerably larger working surface to the wind. These two rotor blades 14 set in the feathered position 25 are therefore forced away to the right by the wind, such that the rotor stabilizes in the position represented.

Represented in FIG. 3 is a situation in which there prevails a wind gradient 21 in which a greater wind speed prevails at a greater height than at a lesser height, such that the upper part of the rotor is subjected to a greater lateral incident wind flow than the lower part. In this case, the upper of the two rotor blades 14 set in the feathered position 25 receives a greater incident flow than the lower one, and is therefore forced more strongly in the direction of the incident wind flow. This causes the rotor 12 to be rotated out of the position represented in FIG. 2, in the extreme case as far as a “Y” position, in which the lower rotor blade 14, turned into a feathered position 25, is rotated into a position pointing vertically downward. In this position, in FIG. 3, it is concealed by the tower 18, and is therefore indicated only by a broken line. In this position, the lower rotor blade 14 presents the greatest possible working surface to the laterally incident wind, such that this position could possibly be exceeded in the case of extreme wind gradients, i.e. in the case of wind conditions that are less suitable for an approach by helicopter.

Both the rotor-blade position represented in FIG. 2 and that represented in FIG. 3 are stable in the case of a constant wind and wind gradient, and can be used for an approach by helicopter. If it is prescribed or otherwise advantageous, the rotor 12 can also be immobilized and/or arrested in this position, wherein, because of the aerodynamic stabilization, the immobilizing or arresting is effected very gently, and does not damage the power train. In the simplest embodiment of the invention, the rotor blades are turned into the feathered position, the nacelle rotates by approximately 90° out of the wind, and any rotor blade is moved into the operating position during or after the turning of the nacelle. After some time, the rotor will automatically stabilize in a position.

A certain feedback control and stabilization of the aerodynamically already stabilized rotor positioning may be effected at the start or, in the case of a changing wind, also by means of pitching the rotor blades 14. Thus, in the case of an excessive wind gradient 21 according to FIG. 3, for example, the upper of the two rotor blades 14 positioned in the feathered position 25 can be rotated somewhat out of the feathered position, in order to present somewhat less working surface to the wind. The rotor then rotates back somewhat again, in the direction of the positioning shown in FIG. 2. Basically, however, even a fixed rotor-blade position of the three rotor blades 14 offers an aerodynamically stabilized rotor-blade positioning in standstill that is suitable for an approach by helicopter.

The sensing of the rotor position is preferably effected by means of one or more rotational-speed sensors and/or rotor-position sensors. According to a particularly preferred embodiment of the invention, it is provided to sense the positioning of the rotor by means of acceleration sensors connected in a rotationally fixed manner to the rotor hub.

Likewise, advantageously, a desired rotor position is maintained with an accuracy of preferably ±10°, in particular preferably ±5°, by means of a rotor-position sensor and a feedback control means. It is thus possible to provide flow conditions that are as constant as possible for an approaching helicopter.

In an advantageous development, the rotor is immobilized or arrested if the feedback control means does not maintain the desired rotor position with the required accuracy, preferably ±10°, in particular ±5°. This may be the case, for example, in the case of particularly turbulent wind conditions or very unfavorable wind gradients. In the case of the latter embodiment, acceleration sensors are used, particularly preferably, for rotor position sensing, because wandering of the rotor is identified particularly rapidly by these sensors.

All stated features, including the features disclosed solely by the drawings and also individual features disclosed in combination with other features, are considered to be material to the invention, singly and in combination. Embodiments according to the invention may be fulfilled by individual features or a combination of a plurality of features.

### LIST OF REFERENCES

10 wind turbine
11 power train
12 rotor
13 rotor hub
14 rotor blade
15 rotor-blade longitudinal axis
16 pitch direction
17 nacelle
18 tower
20 wind gradient
21 wind gradient
24 operating position
25 feathered position

What is claimed is:

1. A method for bringing a wind turbine into a standstill position after a stoppage command, wherein the wind turbine includes a nacelle disposed in a rotatable manner on a tower and a rotor having three rotor blades, and wherein at least two of the three rotor blades can be pitched about a rotor-blade longitudinal axis, the method comprising:
rotating the nacelle into an azimuth position transverse to a wind direction;
bringing a rotor blade into, or holding the rotor blade in, a range of an operating position that corresponds substantially to a blade pitch angle in a partial-load range below a full-load range of the wind turbine; and
bringing each of the other two rotor blades into, or holding each of the two other two rotor blades in, a range of a feathered position;
wherein the rotor, after attainment of the standstill position, is stabilized by incident wind flowing transversely in relation to a direction of a rotor axis.

2. The method as claimed in claim 1, wherein the range of the operating position is one in which profile chords of an outer 30% of a blade length of the rotor blade lie within approximately ±10° of a rotor plane, and wherein the range of the feathered position is one in which profile chords of the outer 30% of the blade length of the rotor blade lie within approximately ±15° of perpendicular to the rotor plane.

3. The method as claimed in claim 1, wherein the rotor, after attainment of the standstill position, is additionally immobilized and/or arrested for a period of time.

4. The method as claimed in claim 1, wherein the period of time is a duration of a helicopter approach.

5. The method as claimed in claim 1, wherein an adjustment of at least one blade angle is effected in dependence on a measured rotor position, and wherein, after stabilization of a desired rotor position, the adjusted blade angles that have been set are retained.

6. The method as claimed in claim 5, wherein the adjustment is effected non-continuously.

7. The method as claimed in claim 1, wherein the nacelle is moved in a predefined direction of rotation, wherein in a case of a cable-twist signal being present, the nacelle is moved in a direction opposite to the predefined direction.

8. The method as claimed in claim 1, wherein rotation of the nacelle and alteration of the blade angles are effected only when the nacelle has already been rotated by more than 60° out of the wind.

9. The method as claimed in claim 1, wherein in the standstill position, the rotor is set in a rotor position that is substantially between a “Y” position, with one rotor blade pointing vertically downward, and a position in which the rotor blade, which is rotated in the range of the operating position, is oriented horizontally and pointing to the wind, wherein the assumed rotor position is kept with a deviation of less than ±10°.

10. The method as claimed in claim 9, wherein the deviation is less than ±5°.

11. A wind turbine comprising:
a nacelle disposed in a rotatable manner on a tower;
a rotor having three rotor blades, of which at least two can be pitched about a rotor-blade longitudinal axis;
a control means;
a wind direction sensor; and
a rotor-position sensor;
wherein the control means is configured to bring the wind turbine into a standstill position after a stoppage command has been received, by rotating the nacelle into an azimuth position transverse to a wind direction, bringing a rotor blade into, or holding the rotor blade in, a range of an operating position that corresponds substantially to a blade pitch angle in a partial-load range below a full-load range of the wind turbine, and bringing each of the other two rotor blades into, or holding each of the two other two rotor blades in, a range of a feathered position.

12. The wind turbine as claimed in claim 11, wherein the wind turbine further comprises an active yaw control system, which effects positioning of the nacelle.

13. The wind turbine as claimed in claim 11, wherein the wind turbine further comprises a braking means and/or an arresting means, which can fix the rotor, at least for a short time, after attainment of a desired rotor position.

14. The wind turbine as claimed in claim 11, wherein the control means is configured to select the rotor blade, which is positioned in the range of the operating position, in dependence on a rotor position signal and a wind direction signal.

15. The wind turbine as claimed in claim 11, wherein the control means is configured to adjust at least one blade angle in dependence on a measured rotor position.

16. The wind turbine as claimed in claim 15, wherein the control means is configured to retain an adjusted blade angle after stabilization of a desired rotor position.
